(19) United States
(12) Patent Application Publication
(10) Pub. No.: US 2012/0075043 A1
(43) Pub. Date: Mar. 29, 2012

(54) CIRCUIT BREAKER WITH A DIGITAL DATA PROCESSING DEVICE

(75) Inventor: Peter Kopaczewski, Berlin (DE)

(73) Assignee: SIEMENS AKTIENGESELLSCHAFT, Munich (DE)

(21) Appl. No.: 13/245,925

(22) Filed: Sep. 27, 2011

(30) Foreign Application Priority Data
Sep. 28, 2010 (DE) 102010041495.6

(51) Int. Cl. H01H 83/18

(52) U.S. Cl. 335/18

(57) ABSTRACT

In a circuit breaker with a digital data processing device, triggering can be effected on the basis of the direction of an energy flow, that is to say whether energy flows from a current source to a load or whether energy is conversely transmitted in the opposite direction from the load. In at least one embodiment, the direction of the energy flow is derived using an item of information relating to the phase relationship between the AC voltage in the circuit in question and the current flowing in the circuit. In this case, it is possible to use switching elements which operate in an analog manner and are provided outside the microcontroller. In at least one embodiment, a simple circuit with flip-flops can be used, for example.

### PRIORITY STATEMENT

The present application hereby claims priority under 35 U.S.C. §119 on German patent application number DE 10 2010 041 495.6 filed Sep. 28, 2010, the entire contents of which are hereby incorporated herein by reference.

### FIELD

At least one embodiment of the invention generally relates to a circuit breaker.

### BACKGROUND

The task of a circuit breaker is to decouple an electrical load (or a plurality of such loads) from a voltage source when a predetermined condition is satisfied. For this purpose, the circuit breaker is connected between this voltage source and the at least one load: it has input connections and output connections, one input connection respectively being connected to one output connection in pairs (there are generally two or four such pairs). The connection can be interrupted by an interruption device.

There are increasingly those circuit breakers in which the interruption device does not operate in an electromechanical manner or does not solely operate in an electromechanical manner but rather is driven by a digital data processing device, typically a microcontroller. Such microcontrollers are increasingly being given new tasks. It is thus known practice, when triggering a circuit breaker, to take into account whether energy flows from the voltage source to the load or vice versa; the latter is the case, for example, when an electric motor provided as the load fails and conversely operates as a generator. From the point of view of the circuit breaker, a distinction is thus made between the situation in which energy is sometimes transmitted from the input connection to the output connection and another time is conversely transmitted from the output connection to the input connection.

The direction of the energy flow has hitherto been determined using the active power. For this purpose, the voltage which supplies the loads is tapped off and the current flowing via the circuit breaker is additionally tapped off and is converted into a voltage. The two voltages produced in this manner can be multiplied by one another. The mathematical sign of the active power indicates the direction of the energy flow. The active power is calculated by the digital data processing device itself. So that the digital data processing device is able to carry out such calculations, it must be provided with a corresponding computing power. However, this disadvantageously results in the direction of the energy flow being taken into account during triggering, for example when determining a triggering current or other operating parameters such as other threshold values, only in expensive connection devices which, overall, are connected in a complicated manner.

### SUMMARY

In at least one embodiment, a greater field of application is ensured as far as the consideration of the energy flow is concerned.

At least one embodiment is directed to a circuit breaker and, according to another aspect of another embodiment, is directed to a method.

In the circuit breaker according to an embodiment of the invention, analog switching elements (which operate in an analog manner) are intended to generate an input signal for the digital data processing device (the input signal being transmitted by means of appropriate coupling of the switching elements, which operate in an analog manner, to the digital data processing device), this being such an input signal from which the digital data processing device can derive (and derives during operation) the direction in which energy is transmitted before interrupting the connection.

At least one embodiment of the invention thus transfers the functionality of determining the direction of the energy flow from the digital data processing device. The switching elements which operate in an analog manner can also be simply subsumed under “switching elements which are arranged outside the digital data processing device and are different from the latter”. In this case, at least one embodiment of the invention is based on the knowledge that switching elements which operate in an analog manner can generate those input signals for the digital data processing device from which the direction of the energy flow can be derived; switching elements which operate in an analog manner can generate an input signal in a simple manner, and signals which have been generated in a simple manner can also comprise or carry a simple item of information such as the information relating to the direction of the energy flow.

As emerges from the method according to at least one embodiment of the invention, the simple input signal may be, in particular, such a signal which carries an item of information relating to the phase relationship between an AC voltage applied to connections of the circuit breaker and the current flowing via the circuit breaker on account of the AC voltage, the direction of the energy flow being able to be derived from this information. If the energy flows in one direction, the current lags the AC voltage and, if the energy flows in the opposite direction, the current leads the voltage.

In one example embodiment of the invention, a first part of the switching elements which operate in an analog manner is designed in such a manner that the AC voltage applied between two connections is preprocessed during operation to form a square-wave signal. A second part of the switching elements which operate in an analog manner is designed in such a manner that, for the purpose of operation, an alternating current flowing on account of the AC voltage is first of all converted into an AC voltage, this AC voltage also being preprocessed in a corresponding manner to form a square-wave signal. A third part of the switching elements which operate in an analog manner is finally designed to generate the input signal by processing the two square-wave signals.

An important item of information can be extracted in a particularly simple manner from square-wave signals. Since, as described above, the phase relationship between the voltage and the current is involved, in particular, square-wave signals suffice since a useful item of information can be derived only on the basis of the zero crossings of the signals.

So that those zero crossings which occur on account of the addition of higher harmonics are not incorrectly determined, the first and second parts of the switching elements which operate in an analog manner can each have at least one filter according to one example embodiment, with the result that only a fundamental wave is filtered from the respective voltage (the AC voltage directly or the alternating current which has been converted into an AC voltage).

In order to generate the square-wave signal from the fundamental wave, a comparator can be used in a simple manner, as can a Schmitt trigger as well.

In one particularly simple embodiment of the invention in which particularly simple switching elements which operate in an analog manner are also used, the third part of switching elements which operate in an analog manner comprises two flip-flops. These flip-flops are connected, in particular, in such a manner that the square-wave signals generated are supplied to the set input of the flip-flops. In addition, the outputs of the flip-flops are coupled to one another via an “AND” circuit (for example an “AND” gate) and the output signals from the flip-flops are thus supplied to an “AND” circuit, the output of the “AND” circuit being coupled to the reset inputs of the flip-flops so that the output signal can ensure a reset operation after the AND function. Furthermore, the output signals from the flip-flops are also supplied to an adding element (adder) whose output signal is in turn supplied to the digital data apparatus.

In the case of the circuit, a different signal is obtained for the duration in which the two square-wave signals do not exhibit the same signal than for the duration in which they exhibit exactly the same signal. The duration of this different signal is a measure of the duration of the phase shift between the alternating current and the AC voltage. However, the mathematical sign of this signal already directly indicates the direction of the energy flow. A somewhat more meaningful item of information than a mere item of information relating to the direction of the energy flow is therefore even obtained, namely an item of information relating to the duration assigned to the phase shift.

In an alternative embodiment of the invention, precise information which goes beyond that can even be obtained: the third part of switching elements which operate in an analog manner comprises an “AND” circuit in this case which is supplied with the two square-wave signals. In contrast, the output signal from the “AND” circuit is supplied to a counter. The latter carries out a counting operation, for which it additionally receives a clock signal. It counts the number of clock pulses for which the sum signal is valid. The result of this counting operation is directly a measure of the phase, for example stated as an angle, between the alternating current and the AC voltage. However, it is possible to derive from this angle information whether the current leads the voltage or vice versa and therefore also the direction of the energy flow. In this case, the digital data processing device allocates particular angular ranges to easily determined directions of the energy flow, either the complete angular range being directly divided by two or two ranges being separated by a range in which a fault of the arrangement is reported.

In this alternative embodiment of the invention, the third part of the switching element which operates in an analog manner preferably also has a frequency divider which is supplied with one of the square-wave signals. The output signal from the frequency divider is supplied to a counter which then carries out the counting operation and thus measures the frequency using a clock signal which is likewise supplied. The result of the counting operation is directly a measure of the period sought.

### BRIEF DESCRIPTION OF THE DRAWINGS

An example embodiment of the invention is described below with reference to the drawing, in which

FIG. 1 illustrates a first embodiment of a circuit arrangement as can be implemented in a circuit breaker according to the invention, and

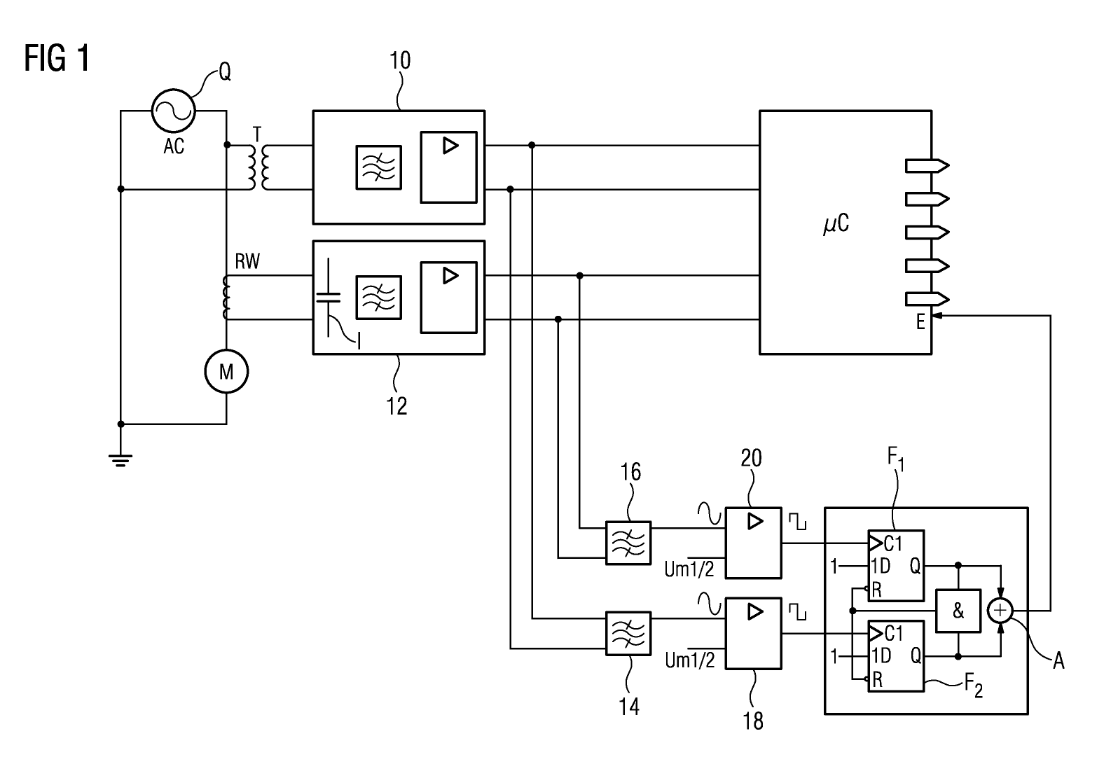

FIG. 2 illustrates a second embodiment of a circuit arrangement as can likewise be implemented in a circuit breaker according to the invention.

In the present case, a description is first of all given of the switching elements (circuit elements) which are common to the two embodiments of the invention. The embodiment is then discussed in detail.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

A circuit breaker is connected in the connection between a voltage source Q and a load, for example a motor M. The circuit breaker can interrupt this connection; for this purpose, it has suitable switching contacts which are not shown in the figures. The switching contacts can be opened under the control of a microcontroller μC which has a controlling effect on a corresponding triggering device which is likewise not shown in the figures for reasons of clarity.

The AC voltage prevailing in the circuit is immediately directly tapped off or, as shown in the figures, is converted into another order of magnitude via a voltage converter (transformer) T. The voltage which has been converted in this manner is supplied to a unit 10 in which band limiting is carried out (by means of a bandpass filter), signal level matching being carried out at the same time. After this so-called matching, the voltage is supplied to the microcontroller.

The current in the circuit containing the voltage source Q and the load M is also measured. In this case, use is made of a so-called Rogowski transducer RW which comprises an air-core coil, for example. The voltage dropped across the coil is equal to the time derivative of the current intensity. So that a signal corresponding to the current intensity is obtained, an integrator I is provided, to be precise as part of a unit 12 in which band limiting and signal level matching are likewise carried out. In this case too, the output signals are supplied to the microcontroller μC.

The output signals from the units 10 and 12 are also additionally supplied to a so-called fundamental wave filter 14 and 16. This filter transmits only a wave with the oscillation with which the voltage source Q emits the voltage.

A square-wave signal is then generated from the fundamental wave in a downstream comparator 18 and 20. Instead of a comparator, it is also possible to provide a Schmitt trigger.

The square-wave voltage is supplied to a respective set input of a flip-flop F₁ and F₂. The voltages output at the outputs of the two flip-flops F₁ and F₂ are combined in an “AND” gate and the signals subjected to the “AND” operation are then supplied to the reset input R of the flip-flops F₁ and F₂, and the output signals are simultaneously added in an adder A and the added signal is supplied to the input E of the microcontroller μC.

The output signal from the adder A is different from zero when precisely the two square-wave signals are different. A phase shift between the square-wave signals and thus between the voltage and the current in the circuit containing the current source Q and the load M is therefore directly imaged in the output signal. The mathematical sign of the output signal from the adder A indicates whether energy is transported from the voltage source Q to the load M or conversely energy flows from the load M to the current source Q during operation of the motor as a generator. Therefore, the microcontroller μC is able to determine the direction in which the energy flows solely on the basis of the mathematical sign of the clock signal applied to the input E. The task of the microcontroller μC is to check whether a predetermined criterion is satisfied before triggering results, that is to say the circuit is interrupted. In this case, the predetermined condition may be different, in particular, depending on whether energy flows from the current source Q to the load M or vice versa.

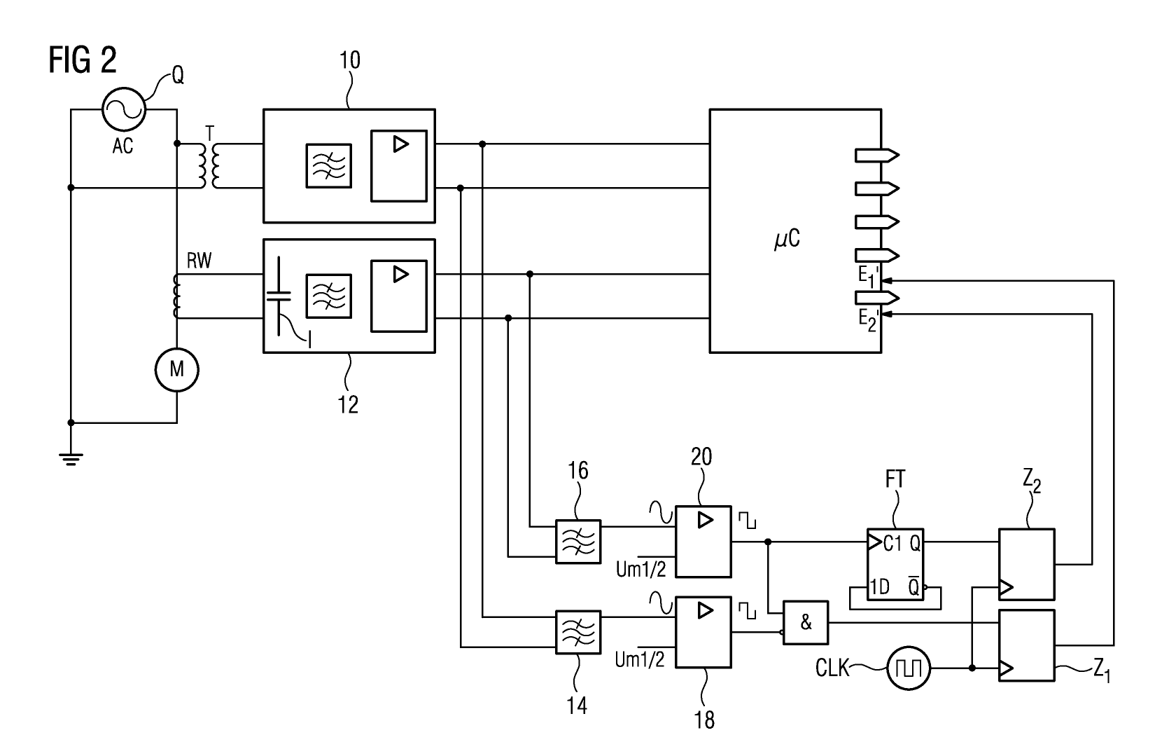

In the embodiment according to FIG. 2, the two square-wave signals are directly supplied to an “AND” gate whose output signal is supplied to a first counter Z₁ which is simultaneously supplied with a clock signal by a clock generator CLK. The counter Z₁ outputs a count value which is a measure of the phase shift between the two square-wave signals and thus between the voltage and the current. The output signal from the counter Z₁ is supplied to the input E′₁ of the microcontroller μC. The latter thus has available a count value for the phase shift between the current and the voltage. In addition, frequency division can be carried out on any desired one of the two square-wave signals by a frequency divider FT, and a counter Z₂ can then carry out a counting operation. In the present case, this is illustrated using the square-wave signal for the current. The output signal from the counter Z₂ is supplied to the input E′₂ of the microcontroller μC. A measure of the period duration of the oscillation is thus available at the input E′₂.

In the embodiment according to FIG. 2, additional information beyond the mere consideration of the direction of the energy flow may also be used, either when determining the triggering criterion or for the microcontroller to undertake further tasks in the device.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A circuit breaker comprising:
input connections;
output connections, the input connections being connected to associated ones of the output connections in pairs, at least one of the connections being interruptable by an interruption device, the interruption device being drivable by a digital data processing device, and the digital data processing device being designed to take into account, in the case of the driving, whether energy is transmitted in the direction from an input connection to an associated output connection or vice versa before the interruption; and
switching elements to operate in an analog manner and intended to generate an input signal for the digital data processing device, wherein a direction in which energy is transmitted, before interrupting the connection, is derivable by the digital data processing device.

2. The circuit breaker as claimed in claim 1, wherein a first part of the switching elements, which operate in an analog manner, is useable to preprocess the AC voltage applied between two connections to form a square-wave signal, and a second part of the switching elements, which operate in an analog manner, is usable to convert the alternating current flowing on account of the AC voltage into an AC voltage and preprocesses the latter to form a square-wave signal, a third part of the switching elements, which operate in an analog manner, being useable to generate the input signal by processing the two square-wave signals.

3. The circuit breaker as claimed in claim 2, wherein the first and second parts of the switching elements, which operate in an analog manner, each comprise at least one filter, with a result that a fundamental wave is filtered from the respective voltage.

4. The circuit breaker as claimed in claim 3, further comprising:
a comparator or a Schmitt trigger, respectively arranged downstream of the filter, to generate the square-wave signal from the fundamental wave.

5. The circuit breaker as claimed in claim 2, wherein the third part of switching elements, which operate in an analog manner, includes two flip-flops, the set input of which is respectively supplied with one of the square-wave signals from the first and second parts of switching elements which operate in an analog manner, the outputs of the flip-flops both being supplied to an “AND” circuit whose output signal is supplied to the reset inputs of the two flip-flops, the outputs of the flip-flops also being supplied to an adding element whose output signal is in turn supplied to the digital data processing device.

6. The circuit breaker as claimed in claim 2, wherein the third part of switching elements, which operate in an analog manner, comprises an “AND” circuit which is supplied with the two square-wave signals and the output signal from which is supplied to a counter which carries out a counting operation using a clock signal, which is likewise supplied, and transmits the result to the digital data processing device.

7. The circuit breaker as claimed in claim 6, wherein the third part of the switching elements, which operate in an analog manner, include a frequency divider which is supplied with one of the square-wave signals and the output signal from which is supplied to a counter, which carries out a counting operation using a clock signal, which is likewise supplied, and transmits the result to the digital data processing device.

8. A method for operating a circuit breaker, in which a connection is interrupted by the circuit breaker on the basis of a direction of an energy flow, the method comprising:
deriving the direction of the energy flow from an item of information relating to a phase relationship between an AC voltage applied to connections of the circuit breaker and current flowing via the circuit breaker on account of the AC voltage.

9. A method for operating a circuit breaker, comprising:
interrupting a connection by the circuit breaker based on a direction of an energy flow, wherein the direction of the energy flow is derived from an item of information relating to a phase relationship between an AC voltage applied to connections of the circuit breaker and current flowing via the circuit breaker on account of the AC voltage.

10. The circuit breaker as claimed in claim 3, wherein the third part of switching elements, which operate in an analog manner, includes two flip-flops, the set input of which is respectively supplied with one of the square-wave signals from the first and second parts of switching elements which operate in an analog manner, the outputs of the flip-flops both being supplied to an “AND” circuit whose output signal is supplied to the reset inputs of the two flip-flops, the outputs of the flip-flops also being supplied to an adding element whose output signal is in turn supplied to the digital data processing device.

11. The circuit breaker as claimed in claim 3, wherein the third part of switching elements, which operate in an analog manner, comprises an “AND” circuit which is supplied with the two square-wave signals and the output signal from which is supplied to a counter which carries out a counting operation using a clock signal, which is likewise supplied, and transmits the result to the digital data processing device.

12. The circuit breaker as claimed in claim 11, wherein the third part of the switching elements, which operate in an analog manner, include a frequency divider which is supplied with one of the square-wave signals and the output signal from which is supplied to a counter, which carries out a counting operation using a clock signal, which is likewise supplied, and transmits the result to the digital data processing device.
